(19) United States
(12) Patent Application Publication
(10) Pub. No.: US 2015/0199406 A1
(43) Pub. Date: Jul. 16, 2015

(54) METHOD AND DEVICE FOR FILTERING SYSTEM EVENTS, TERMINAL, AND STORAGE MEDIUM

(71) Applicant: TENCENT TECHNOLOGY (SHENZHEN) COMPANY LIMITED, Shenzhen (CN)

(72) Inventor: Jiahui Liang, Shenzhen (CN)

(21) Appl. No.: 14/378,304

(22) Filed: Aug. 12, 2014

Related U.S. Application Data
(63) Continuation of application No. PCT/CN2013/090937, filed on Dec. 30, 2013.

(30) Foreign Application Priority Data
Apr. 19, 2013 (CN) 201310138115.2

(51) Int. Cl. G06F 17/30

(52) U.S. Cl. CPC G06F 17/30483

(57) ABSTRACT

A method and device for filtering system events, a terminal, and a storage medium is provided. With the technical solution provided by the invention, by searching for the frequent event in the system event set, the frequent event for which the current time is within the system time window cycle can be discarded, so that the number of the system events sent to the application units in the system can be decreased, thus decreasing the redundant computations within the system, saving system resources, and reducing the power consumptions by the system. The technical solutions according to the present disclosure can be integrated within the operating system at a terminal, or can be independent of the operating system, which facilitates the subsequent product updates and developments.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to and is a continuation of PCT/CN2013/090937, filed on Dec. 30, 2013 and entitled “METHOD AND DEVICE FOR FILTERING SYSTEM EVENTS, TERMINAL, AND STORAGE MEDIUM”, which claims the benefit of Chinese Patent Application No. 201310138115.2, filed with the Chinese Patent Office on Apr. 19, 2013 by TENCENT TECHNOLOGY (SHENZHEN) CO., LTD. and titled “METHOD AND DEVICE FOR FILTERING SYSTEM EVENTS, AND TERMINAL”, the contents of which are incorporated herein by reference in their entirety.

### BACKGROUND

1. Field

The present disclosure relates to the field of operating system software technologies, in particular to a method and device for filtering system events, a terminal, and a storage medium.

2. Description of the Related Art

In the operating systems of computers, mobile phones and Tablet PCs, system events are triggered by the monitored external events and then sent to the CPU or other functional units with instruction calculating and processing capabilities. Among them, however, numerous identical system event processing instructions are present.

In the case of a traffic monitoring application, for example, a system event is triggered and sent to a traffic monitoring unit after an external event of receiving data traffic is detected in the system, and then the traffic monitoring unit starts to process the system event. Due to the ongoing external event of receiving data traffic, lots of system events to be sent to the traffic monitoring unit will be accordingly triggered in a time period. However, a user concerning about the traffic monitoring usually desires to know merely the overall traffic in a time period, therefore the traffic monitoring unit is not required to deal with all the system events during the time period.

Other functional units in the system may be also involved in the same situation mentioned above, that is, although there are lots of repetitive system events requiring for processing within a time period, the functions of the functional units as well as the user experience will not be impacted if only a part of these system events are processed by the functional units. Therefore, it is unnecessary to process all of the repetitive system events, and results in redundant system computations and excessive system resource occupations, thus causing more power consumptions due to the operation of the system.

### SUMMARY

In view of the above problems, an embodiment of the present disclosure provides a method and device for filtering system events, a terminal, and a storage medium, which solve the technical problems of excessive redundant system computations caused by processing a large number of repetitive system events.

The present disclosure employs the following technical solutions.

A method for filtering system events includes:
searching for a frequent event in a system event set according to a preset frequent event set by a device, to determine whether the the frequent event is present in the system event set;
determining whether the current time is within a system time window cycle by the device if the frequent event is present in the system event set; and
discarding the frequency event in the system event set by the device if it is determined that the current time is within the system time window cycle.

A device for filtering system events, which includes at least a processor operating in conjunction with a memory and a plurality of units, wherein the plurality of units includes:
a searching unit, which is configured for searching for a frequent event in a system event set according to a preset frequent event set, to determine whether the frequent event is present in the system event set;
a determining unit, which is configured for determining whether the current time is within a system time window cycle if the frequent event is present in the system event set; and
a filtering unit, which is configured for discarding the frequency event in the system event set if it is determined by the determining unit that the current time is within the system time window cycle.

A terminal includes the above device for filtering system events.

A non-transitory storage medium contains computer-executable instructions, where the computer executable instructions, when executed by a computer processor, are configured for performing a method for filtering system events, wherein the method for filtering system events includes:
searching for a frequent event in a system event set according to a preset frequent event set, to determine whether the frequent event is present in the system event set;
determining whether the current time is within a system time window cycle if the frequent event is present in the system event set; and
discarding the frequency event in the system event set if it is determined that the current time is within the system time window cycle.

With the technical solution provided by the invention, by searching for the frequent event in the system event set and using the time window mechanism, the redundant frequent events generated in the system within a certain period can be reduced and the number of the system events sent to the application units in the system can be decreased, thus decreasing the redundant computations within the system, saving system resources, and reducing the power consumptions by the system.

### BRIEF DESCRIPTION OF THE DRAWINGS

FIG. 1 is a schematic flow chart of the method for filtering system events provided by a first embodiment.

FIG. 2 is a structural representation of the device for filtering system events provided by the first embodiment.

FIG. 3 is a schematic flow chart of the method for filtering system events provided by a second embodiment.

FIG. 4 is a structural representation of the device for filtering system events provided by the second embodiment.

FIG. 5 is a schematic flow chart of the method for filtering system events provided by a third embodiment

FIG. 6 is a structural representation of the device for filtering system events provided by the third embodiment.

### DETAILED DESCRIPTION

The technical solutions of the present disclosure will be further illustrated through the specific embodiments in conjunction with the accompanying drawings.

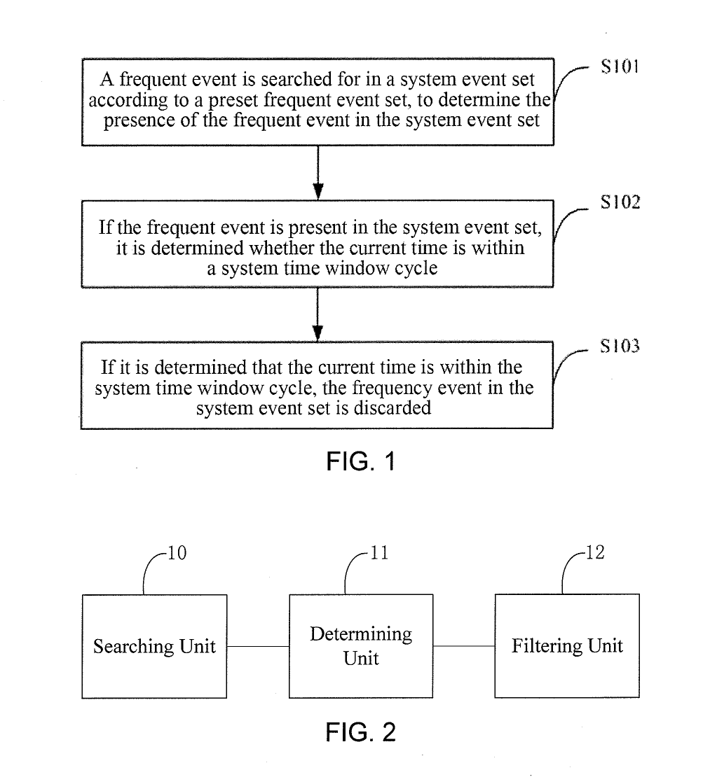

FIG. 1 is a schematic flow chart of the method for filtering system events provided by a first embodiment, and the method includes steps S101 to S103 below.

At Step S101, a frequent event is searched for in a system event set according to a preset frequent event set by a device, to determine the presence of the frequent event in the system event set.

The system event set is composed of elements representing the current system events, and the frequent event set is composed of elements representing the preset frequent events which occur frequently within the system. The searching for a frequent event in the system event set is equivalent to acquiring an intersection between the system event set and the frequent event set, and the element of the intersection is considered as the frequent event. The device may be a server, a computer, or a processing device.

For example, if an intersection between the system event set S and the frequent event set S′ contains elements a and b, the elements a and b represent the frequent events present in the system event set S; otherwise, if the intersection does not contain any element, the system event set does not contain any frequent event.

At Step S102, if the frequent event is present in the system event set by the device, it is determined whether the current time is within a system time window cycle.

The system time window cycle is a time interval preset by the system to filter out any frequent event which meets time requirements, in other words, a frequent event will be filtered out only if the occurrence frequency of the frequent event is high enough. When the system event set contains the frequent event, the current time is acquired to determine whether the current time is within the system time window cycle. The frequent events generated within the time interval in the system can be filtered out according to the embodiments.

For example, in the case that the current time is indicated by t, the system time window cycle is indicated by T, and the starting time of the system time window cycle is indicated by t′; if t-t′<T, then it is determined that the current time is within the system time window cycle.

At Step S103, if it is determined that the current time is within the system time window cycle by the device, the frequency event in the system event set is discarded.

After it is determined that the current time is within the system time window cycle, the frequent event searched out at Step S101 is discarded from the system event set. For example, if the frequent events a and b are obtained by comparing the system event set S with the frequent event set S′ and the occurrence time of the frequent events a and b is within the system time window cycle, the frequent events a and b in the system event set S are discarded.

Preferably, at Step S102, all the system events in the system event set are maintained if the system event set does not contain any frequent event.

If the system event set does not contain any frequent event, it is certainly unnecessary to determine whether the current time is within the system time window cycle, and all system events in the system event set are maintained.

Preferably, at Step S103, if the current time is not within the system time window cycle (for example, in the case that the current time is indicated by t, the system time window cycle is indicated by T, and the starting time of the system time window cycle is indicated by t′; if t-t′>T, it is determined that the current time is not within the system time window cycle), then:
the starting time of the system time window cycle is updated by the current time t, that is, t′=t; and
all the system events in the system event set are maintained, and at this time, the current time is not within the system time window cycle, and hence each of the system events in the system event set is not considered as the frequent event.

Correspondingly, the first embodiment of the present disclosure also provides a device for filtering system events, which is used to embody the method shown in FIG. 1. As shown in FIG. 2, the device for filtering system events provided by the embodiment includes at least a processor operating in conjunction with a memory and a plurality of units, wherein the plurality of units includes:
a searching unit 10, which is configured for searching for a frequent event in a system event set according to a preset frequent event set, to determine whether the frequent event is present in the system event set;
a determining unit 11, which is configured for determining whether the current time is within a system time window cycle if the frequent event is searched out in the system event set by the searching unit 10; and
a filtering unit 12, which is configured for discarding the frequency event in the system event set if it is determined by the determining unit 11 that the current time is within the system time window cycle.

Exemplarily, the determining unit 11 is also configured for maintaining all the system events in the system event set if the system event set does not contain the frequent event.

Exemplarily, the filtering unit 12 is also configured for updating the starting time of the system time window cycle as the current time and maintaining all the system events in the system event set, if it is determined by the determining unit 11 that the current time is not within the system time window cycle.

Exemplarily, the device may further include a monitoring unit, which is configured for monitoring the system events and generating the system event set before the searching unit 10 searches for the frequent event in the system event set according to the preset frequent event set.

Exemplarily, the device may further include a takeover unit, which is configured for taking over the operating system by logic injection before the monitoring unit monitors the system events and generates the system event set.

Exemplarily, the device may further include a sending unit, which is configured for sending a system event in the current system event set to a system application module corresponding to the system event after the filtering unit 12 discards the frequent event in the system event set.

In the first embodiment of the present disclosure, by searching for the frequent event in the system event set and using the time window mechanism, the redundant frequent events generated in the system within a certain period can be reduced and the number of the system events sent to the application units in the system can be decreased, thus decreasing the redundant computations within the system, saving system resources, and reducing the power consumptions by the system. The technical solutions according to the first embodiment of the present disclosure can be integrated within the operating system at a terminal, or can be embodied as an application program to take over the operation system by the logic injection, to achieve the above technical effects.

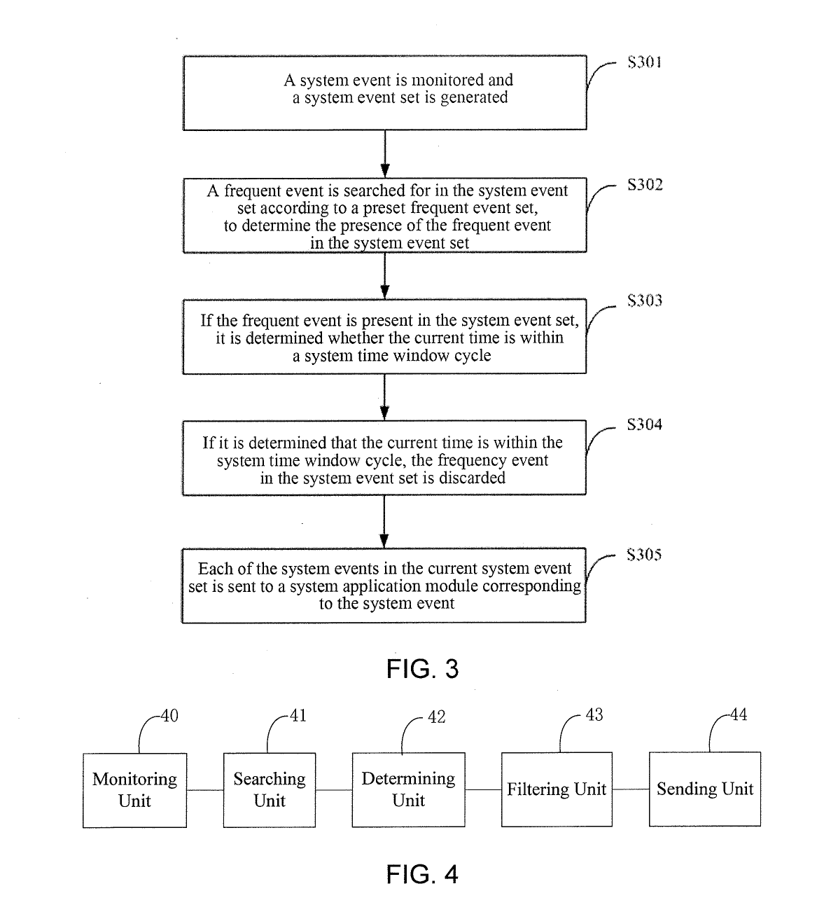

FIG. 3 is a schematic flow chart of the method for filtering system events provided by a second embodiment, and the method includes Steps S301 to S305 below.

At Step S301, a system event is monitored and a system event set is generated.

For example, after an external event is detected by the operating system, a system event is triggered correspondingly and sent to a system application module corresponding to the system event. At this point, the system event generated by the operating system due to the external event can be monitored, and the system events generated by the operating system within a system clock cycle form a system event set.

At Step S302, a frequent event is searched for in the system event set according to a preset frequent event set, to determine whether the presence of the frequent event in the system event set.

This step is the same as Step S101 in the first embodiment, and will not be discussed again herein.

At Step S303, if the frequent event is present in the system event set, it is determined whether the current time is within a system time window cycle.

This step is the same as Step S102 in the first embodiment, and will not be discussed again herein.

At Step S304, if it is determined that the current time is within the system time window cycle, the frequency event in the system event set is discarded.

This step is the same as Step S103 in the first embodiment, and will not be discussed again herein.

In Step S305, each of the system events in the current system event set is sent to a system application module corresponding to the system event.

The system application module is responsible for processing the system events in the system event set in the system. For example, after the frequent events have been discarded from the system event set, if a certain system event, which is triggered after the operating system detects an external event of receiving data traffic, is present in the system event set, then the system application unit corresponding to this system event is a traffic monitoring unit for detecting the data traffic in the operating system, and accordingly the system event is sent to the traffic monitoring unit for detecting the data traffic in the operating system.

Correspondingly, the second embodiment of the present disclosure provides a device for filtering system events, which is used for embodying the method shown in FIG. 3. As shown in FIG. 4, the device for filtering system events provided by the present embodiment includes:
a monitoring unit 40, which is configured for monitoring a system event and generating a system event set;
a searching unit 41, which is configured for searching for a frequent event in the system event set according to a preset frequent event set, to determine the presence of the frequent event in the system event set;
a determining unit 42, which is configured for determining whether the current time is within a system time window cycle if it is searched by the searching unit 41 that the frequent event is present in the system event set;
a filtering unit 43, which is configured for discarding the frequency event from the system event set if it is determined by the determining unit 42 that the current time is within the system time window cycle; and
a sending unit 44, which is configured for sending each of the system events in the current system event set to a system application unit corresponding to the system event.

With the method and device for filtering system events provided by the second embodiment of the present disclosure, the system events triggered by the system due to the detected external events can be effectively monitored and filtered to discard the redundant frequent events, so that the system events without the redundant frequent events are sent to the system application units, thus decreasing the redundant computations within the system, saving the system resources, and reducing the power consumptions by the system. The method according to the second embodiment of the present disclosure can be integrated to the operating system at a terminate but shall be adapted to different types or even different versions of operating systems.

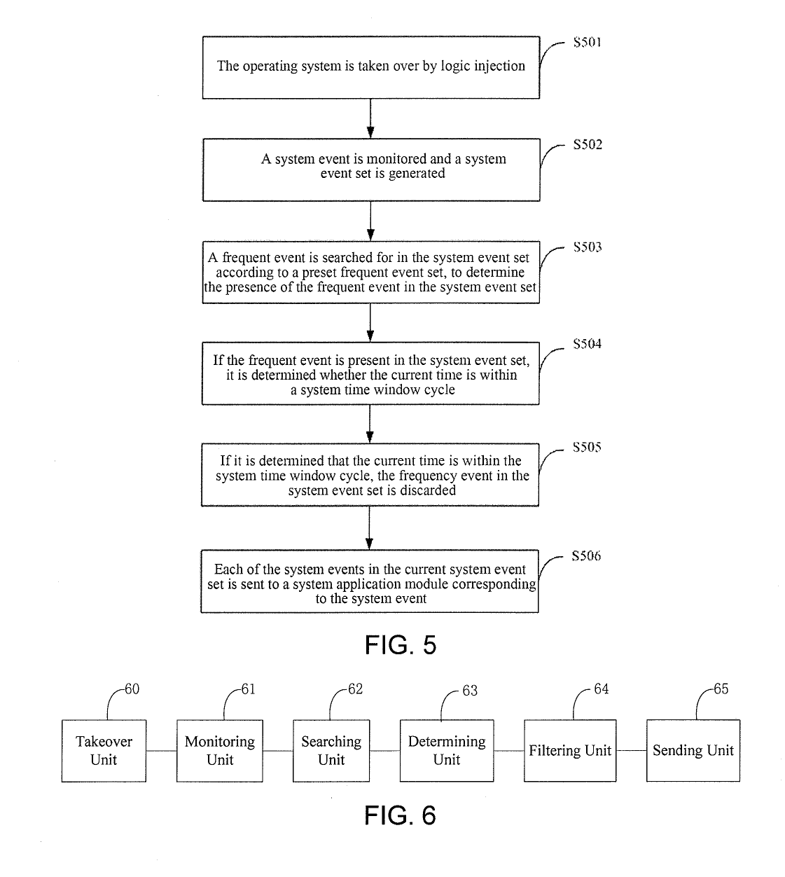

In view of this, if the method according to the second embodiment is independent of the operating system, it is more advantageous for product development and update, and it is convenient for the users to download or choose the function based on the method. As shown in FIG. 5, a third embodiment of the present disclosure provides a method for filtering system events which is independent of the operating system, and the method includes Steps S501 to S506 below.

At Step S501, the operating system is taken over by logic injection.

After a logic program independent of the operating system is started, the original logic, by which the system events are directly sent to the system application units in the operating system, is changed such that the system events are taken over by the program independent of the operating system, in order to monitor and manage the system events generated by the operating system.

At Step S502, a system event is monitored and a system event set is generated.

This step is the same as Step S301 in the second embodiment, and will not be discussed again herein.

At Step S503, a frequent event is searched for in the system event set according to a preset frequent event set, to determine whether the presence of the frequent event in the system event set.

This step is the same as Step S302 in the second embodiment, and will not be discussed again herein.

At Step S504, if the frequent event is present in the system event set, it is determined whether the current time is within a system time window cycle.

This step is the same as Step S303 in the second embodiment, and will not be discussed again herein.

At Step S505, if it is determined that the current time is within the system time window cycle, the frequent event in the system event set is discarded.

This step is the same as Step S304 in the second embodiment, and will not be discussed again herein.

At Step S506, each of the system events in the current system event set is sent to a system application unit corresponding to the system event.

This step is the same as Step S305 in the second embodiment, and will not be discussed again herein.

Correspondingly, the third embodiment of the present disclosure further provides a device for filtering system events, which is used for embodying the method shown in FIG. 5. As shown in FIG. 6, the device provided by the present embodiment includes:
a takeover unit 60, which is configured for taking over the operating system by logic injection;
a monitoring unit 61, which is configured for monitoring a system event and generating a system event set;
a searching unit 62, which is configured for searching for a frequent event in the system event set according to a preset frequent event set, to determine whether the presence of the frequent event in the system event set;
a determining unit 63, which is configured for determining whether the current time is within a system time window cycle if the frequent event is searched out in the system event set by the searching unit 62;
a filtering unit 64, which is configured for discarding the frequency event from the system event set if it is determined by the determining unit 63 that the current time is within the system time window cycle; and
a sending unit 65, which is configured for sending each of the system events in the current system event set to a system application unit corresponding to the system event.

With the method and device for filtering system events provided by the third embodiment of the present disclosure, the system event triggered by the system due to the detected external events can be effectively monitored, and filtered to discard the redundant frequent events, so that the system events without the redundant frequent events are sent to the system application units, thus decreasing the redundant computations within the system, saving system resources, and reducing the power consumptions by the system. Moreover, the method is independent of the operating system by means of taking over the operating system, which facilitates the subsequent product updates and developments, and it is convenient for the users to choose by themselves whether to download and use the function based on the method in the terminal operating system.

An embodiment of the present disclosure also provides a terminal, which includes the device for filtering system events provided by the first, second or third embodiment of the present disclosure, and the terminal can be various computing terminals such as a computer, a mobile phone, a tablet PC and the like.

With the method and device for filtering system events provided by the above embodiment of the present disclosure, by searching for the frequent event in the system event set and using the time window mechanism, the redundant frequent events generated in the system within a certain period can be reduced and the number of the system events sent to the application units in the system can be decreased, thus decreasing the redundant computations within the system, saving system resources, and reducing the power consumptions by the system; on the other hand, with the above-mentioned method, the system event triggered by the system due to the detected external events can be effectively monitored, and filtered to discard the redundant frequent events, so that the system events without the redundant frequent events are sent to the system application units, thus decreasing the redundant computations within the system, saving system resources, and reducing the power consumptions by the system. Moreover, the method is independent of the operating system by means of taking over the operating system, which facilitates the subsequent product updates and developments, and it is convenient for the users to choose by themselves whether to download and use the function based on the method in the terminal operating system.

An embodiment of the present disclosure also provides a non-transitory storage medium containing computer-executable instructions, which, when executed by a computer processor, are configured for performing steps of:
searching for a frequent event in a system event set according to a preset frequent event set, to determine whether the the frequent event is present in the system event set;
determining whether the current time is within a system time window cycle if the frequent event is present in the system event set; and
discarding the frequency event in the system event set if it is determined that the current time is within the system time window cycle.

Exemplarily, the computer executable instructions are further configured for performing a step of maintaining all system events in the system event set if the system event set does not contain the frequent event.

Exemplarily, the computer executable instructions are further configured for performing a step of updating the starting time of the system time window cycle as the current time and maintaining all the system events in the system event set if it is determined that the current time is not within the system time window cycle.

Exemplarily, the computer executable instructions are further configured for performing a step of monitoring the system event and generating the system event set before the step of searching for a frequent event in a system event set according to a preset frequent event set.

Exemplarily, the computer executable instructions are further configured for performing a step of taking over the operating system by logic injection before the step of monitoring the system event and generating the system event set.

Exemplarily, the computer executable instructions are further configured for performing a step of sending each of the system events in the current system event set to a system application unit corresponding to the system event after the step of discarding the frequency event in the system event set.

It should be noted by those skilled in the art that various units or steps in the above-described embodiments can be realized with general-purpose computing devices, and can be centralized on a single computing device or distributed on a network composed of a plurality of computing devices. Optionally, the units or steps may be realized by program codes executable by the computing device, and the codes can be stored in the storage device and executed by the computing device, or the units or steps may be respectively embodied into various integrated circuit units, or some of the units or steps may be embodied into a single integrated circuit. Thus, the present disclosure is not limited to the combination of any specific hardware and software.

The above description only shows some preferred embodiments of the present disclosure, rather than being interpreted as the limitation to the present disclosure. Variations and substitutions made by those skilled in the art without departing from the scope disclosed by the invention shall fall within the protection scope of the present disclosure. Accordingly, the scope of the protection of the present disclosure is defined by the attached claims.

What is claimed is:

1. A method for filtering system events, comprising:
searching for a frequent event in a system event set according to a preset frequent event set by a device, to determine whether the frequent event is present in the system event set;
determining whether the current time is within a system time window cycle by the device if the frequent event is present in the system event set; and
discarding the frequency event in the system event set by the device if it is determined that the current time is within the system time window cycle.

2. The method of claim 1, further comprising:
maintaining all the system events in the system event set if the system event set does not include the frequent event.

3. The method of claim 1, further comprising:
updating a starting time of the system time window cycle as the current time and maintaining all the system events in the system event set, if it is determined that the current time is not within the system time window cycle.

4. The method of claim 1, further comprising: monitoring the system events; and generating the system event set, before searching for the frequent event in the system event set according to the preset frequent event set.

5. The method of claim 4, further comprising: taking over the operating system by logic injection before monitoring the system events and generating the system event set.

6. The method of claim 1, further comprising: sending the system event in the current system event set to a system application unit corresponding to the system event after discarding the frequent event in the system event set.

7. A device for filtering system events, which comprises at least a processor operating in conjunction with a memory and a plurality of units, wherein the plurality of units comprises:
a searching unit configured to search for a frequent event in a system event set according to a preset frequent event set, to determine whether the frequent event is present in the system event set;
a determining unit configured to determine whether the current time is within a system time window cycle if the frequent event is present in the system event set; and
a filtering unit configured to discard the frequency event in the system event set if it is determined by the determining unit that the current time is within the system time window cycle.

8. The device of claim 7, wherein the determining unit is further configured to maintain all the system events in the system event set if the system event set does not include the frequent event.

9. The device of claim 7, wherein the filtering unit is further configured to update a starting time of the system time window cycle as the current time and maintain all the system events in the system event set, if the determining unit determines that the current time is not within the system time window cycle.

10. The device of claim 7, further comprising a monitoring unit configured to monitor the system events and generate the system event set before the searching unit searches for the frequent event in the system event set according to the preset frequent event set.

11. The device of claim 10, further comprising a takeover unit configured to take over the operating system by logic injection before the monitoring unit monitors the system events and generates the system event set.

12. The device of claim 7, further comprising: a sending unit configured to send the system event in the current system event set to a system application unit corresponding to the system event after the filtering unit discards the frequent event in the system event set.

13. A terminal, comprising a device for filtering system events, which comprises at least a processor operating in conjunction with a memory and a plurality of units, wherein the plurality of units comprises:
a searching unit configured to search for a frequent event in a system event set according to a preset frequent event set, to determine whether the frequent event is present in the system event set;
a determining unit configured to determine whether the current time is within a system time window cycle if the frequent event is present in the system event set; and
a filtering unit configured to discard the frequency event in the system event set if the determining unit determines that the current time is within the system time window cycle.

14. The method of claim 2, further comprising:
updating the starting time of a system time window cycle as the current time and maintaining all the system events in the system event set, if it is determined that the current time is not within the system time window cycle.

15. The method of claim 2, further comprising: monitoring the system events and generating the system event set, before searching for the frequent event in the system event set according to the preset frequent event set.

16. The method of claim 2, further comprising: sending the system event in the current system event set to a system application unit corresponding to the system event after discarding the frequent event in the system event set.

17. The device of claim 8, wherein the filtering unit is further configured to update a starting time of the system time window cycle as the current time and maintain all the system events in the system event set, if the determining unit determines that the current time is not within the system time window cycle.

18. The device of claim 8, further comprising a monitoring unit configured to monitor the system events and generate the system event set before the searching unit searches for the frequent event in the system event set according to the preset frequent event set.
